(19) United States
(12) Patent Application Publication
(10) Pub. No.: US 2017/0353698 A1
(43) Pub. Date: Dec. 7, 2017

(54) METHOD AND APPARATUS OF ADD-ON WIRELESS CAMERA SOLUTION FOR VEHICULAR TRAILER APPLICATIONS

(71) Applicant: GM GLOBAL TECHNOLOGY OPERATIONS LLC, DETROIT, MI (US)

(72) Inventors: FAN BAI, ANN ARBOR, MI (US); DAN SHAN, TROY, MI (US); JINSONG WANG, TROY, MI (US); ROBERT ANTHONY BORDO, HARRISON TOWNSHIP, MI (US); MARCO ROCCO, TROY, MI (US)

(21) Appl. No.: 15/175,950

(22) Filed: Jun. 7, 2016

(51) Int. Cl. H04N 7/18; H04W 24/08; B60R 1/00; H04L 5/00; H04W 76/02; H04W 28/02

(52) U.S. Cl. CPC H04N 7/181; H04W 76/02; H04W 28/0289; H04W 28/0252; B60R 1/002; H04L 5/0012; H04W 24/08; B60R 2300/105; B60R 2300/806

(57) ABSTRACT

A method and apparatus are disclosed for wirelessly communicating signals from trailer-mounted cameras to a towing vehicle, where the techniques overcome packet loss challenges caused by interferences, fading and poor signal strength. An advanced spectrum hopping algorithm monitors conditions on multiple channels in multiple frequency bands, detects congestion or collisions needing mitigation, and migrates transmissions as needed to other channels with greater free capacity. Network coding techniques are provided which transmit data packets via multiple paths, where the redundancy provides robustness against data packet losses. The multiple path network coding approach may include spectral diversity, where packets are transmitted on different bands, and spatial diversity, where packets are transmitted via different routes such as direct and repeater-based.

### BACKGROUND OF THE INVENTION

### Field of the Invention

This invention relates generally to wireless cameras used with vehicles and, more particularly, to a method for improving the performance and reliability of wireless communications between cameras mounted on trailers and the towing vehicle, where the method uses channel hopping, spectrum hopping, network coding and path diversity techniques to achieve improved communications.

### Discussion of the Related Art

Modern digital cameras are used in many vehicle-related applications—providing images for a driver's viewing, and providing input for automated systems such as parking assist and lane keeping. It is desirable to extend the advantages of digital cameras to vehicle trailer applications, but this application has proved problematic to implement.

It is, of course, possible to use hardwired connections to communicate signals from a trailer-mounted camera to the towing vehicle. However, the signal and power wires increase weight and cost, and represent a significant reliability disadvantage due to wire wear and the possibility of pinching or severing of the wires. In addition, hardwired trailer camera implementations must anticipate the number and location of cameras on the trailer—and both the vehicle and the trailer must be wired to accommodate the anticipated configuration of cameras. These disadvantages have prevented the widespread use of trailer-mounted cameras.

It is far preferable to use wireless technology to communicate signals from trailer-mounted cameras to the towing vehicle. Unfortunately, wireless camera communications have suffered from poor performance and reliability issues, due to the challenges in wirelessly communicating the relatively high-bandwidth camera video signals from the trailer to the towing vehicle under highly dynamic driving environments.

### SUMMARY OF THE INVENTION

In accordance with the teachings of the present invention, a method and apparatus are disclosed for wirelessly communicating signals from trailer-mounted cameras to a towing vehicle, where the techniques overcome packet loss challenges caused by interferences, multi-path fading, shadowing and poor signal strength. An advanced spectrum hopping algorithm monitors conditions on multiple channels in multiple frequency bands, detects congestion or collisions needing mitigation, and migrates transmissions as needed to other channels with greater free capacity. Network coding techniques are provided which transmit data packets via multiple paths, where the redundancy in both the data and the transmission path provides robustness against data packet losses. The multiple path network coding approach may include spectral diversity, where packets are transmitted on different bands, and spatial diversity, where packets are transmitted via different routes such as direct and repeater-based.

Additional features of the present invention will become apparent from the following description and appended claims, taken in conjunction with the accompanying drawings.

### BRIEF DESCRIPTION OF THE DRAWINGS

FIG. 1 is an illustration of a group of wireless transmissions over multiple channels in multiple frequency bands, where collisions between the transmissions occur on some of the channels;

FIG. 2 is a block diagram of a system for managing wireless communications between trailer-mounted cameras and a towing vehicle;

FIG. 3 is an illustration of a group of wireless transmissions over multiple channels in multiple frequency bands, where collisions between the transmissions are eliminated by migrating some of the transmissions to different channels using the system of FIG. 2;

FIG. 4 is a flowchart diagram of a method for selecting wireless frequency bands and channels for multiple trailer-mounted cameras communicating with the host vehicle;

FIGS. 5 A/B/C are conceptual diagrams illustrating how duplication and network coding techniques can be used to overcome packet loss and improve video frame recovery; and

FIG. 6 is a flowchart diagram of a method for managing wireless communications between trailer-mounted cameras and a towing vehicle.

### DETAILED DESCRIPTION OF THE EMBODIMENTS

The following discussion of the embodiments of the invention directed to reliable wireless communications between trailer-mounted cameras and a towing vehicle is merely exemplary in nature, and is in no way intended to limit the invention or its applications or uses. For example, the discussion below is directed to cameras on a trailer communicating with the towing vehicle, but the methods and system are equally applicable to any wireless camera image transmission application.

Many modern vehicles include cameras which provide images of scenes in and around the vehicle, where the images can be viewed as video by the driver, or the images can be used in automated systems such as parking assistance and lane keeping assistance. Such cameras are typically installed as original equipment by vehicle manufacturers, who integrate the cameras and the interfaces with vehicle video displays and other vehicle systems. Furthermore, vehicle-based cameras can typically easily be hardwired for both power and data signals, as the cameras are included in the vehicle specification and comprehended in vehicle design from the beginning.

Many applications can be envisioned where trailer-mounted cameras could be employed to the benefit of the driver of the towing vehicle. These applications include trailer docking, trailer backing assistance and/or automation, boat launching/landing, trailer cornering clearance, trailer tire monitoring, trailer interior cabin monitoring, and others. The aforementioned applications may display raw video feeds from multiple cameras, or provide composite synthesized images such as a bird's eye view, or a combination of both types of views.

Unlike vehicle-mounted cameras, however, the number and placement of trailer-mounted cameras are not specified by vehicle manufacturers. For this and other reasons, it is highly desirable to use wireless communications between trailer-mounted cameras and the towing vehicle. Many challenges must be overcome, however, in order to ensure reliable, high quality video from multiple trailer-mounted cameras using wireless communications. These challenges include wireless traffic congestion on channels in the Industrial, Scientific and Medical (ISM) radio frequency bands of 2.4 GHz and 5 GHz, out-of-band interference from other neighboring bands, varying conditions due to mobility and blockage/fading effects, and range coverage issues for long trailers.

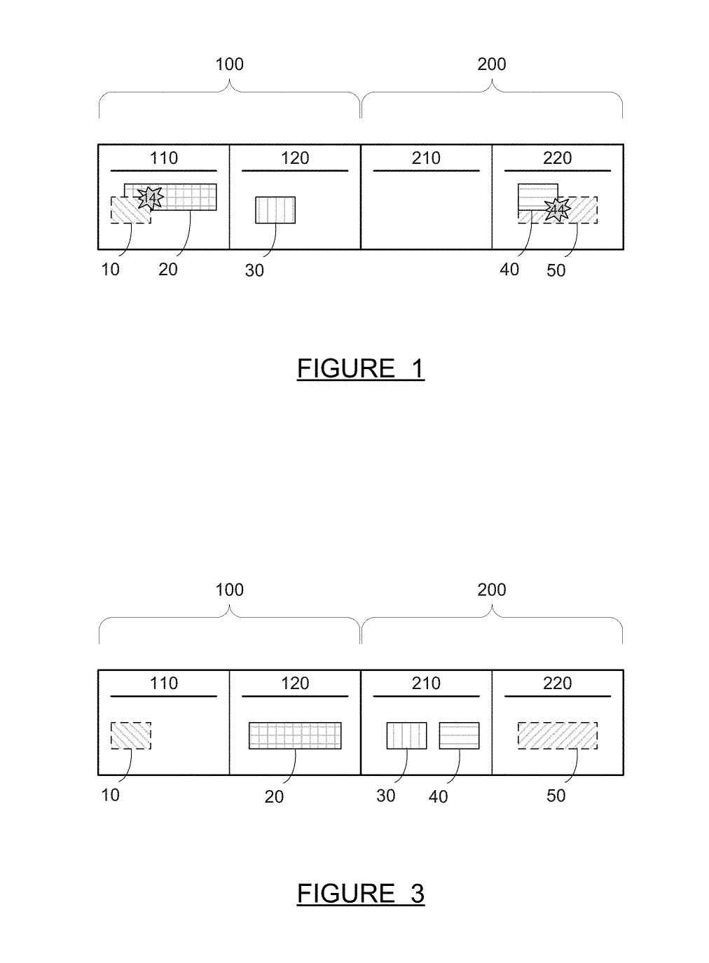

FIG. 1 is an illustration of a group of wireless transmissions over multiple channels in multiple frequency bands, where collisions between the transmissions occur on some of the channels. A first wireless communications band 100 includes channels 110 and 120, among others not shown. A second wireless communications band 200 includes channels 210 and 220, among others. The bands 100 and 200 may represent the ISM frequency bands of 2.4 GHz and 5 GHz, which are commonly used for consumer wireless or “Wi-Fi” communications. The channels 110, 120, 210 and 220 can be any channels within the bands 100 and 200, where the actual channels would have designations such as Channel 1, Channel 11, Channel 151 and Channel 181.

At a particular moment in time, wireless transmissions 10, 20, 30, 40 and 50 occur in the bands 100 and 200. It can be seen in FIG. 1 that the transmissions 10 and 20 both occur on the channel 110 at the same time, resulting in a collision as shown at 14. It can also be seen that the transmissions 40 and 50 both occur on the channel 220 at the same time, resulting in a collision as shown at 44. In the scenario shown in FIG. 1, the transmissions 10 and 50 (shown with dashed outlines) are transmissions or interference from an external source—that is, a source over which a channel management system on a host vehicle/trailer has no control. The external transmissions 10 and 50 may be from wireless equipment on passing vehicles using the channels 110/220, may be side-band noise from another channel, or otherwise. In any case, the transmissions 10 and 50, which cause the collisions 14 and 44, cannot be controlled but must be compensated for because they are disruptive to the transmissions 20 and 40.

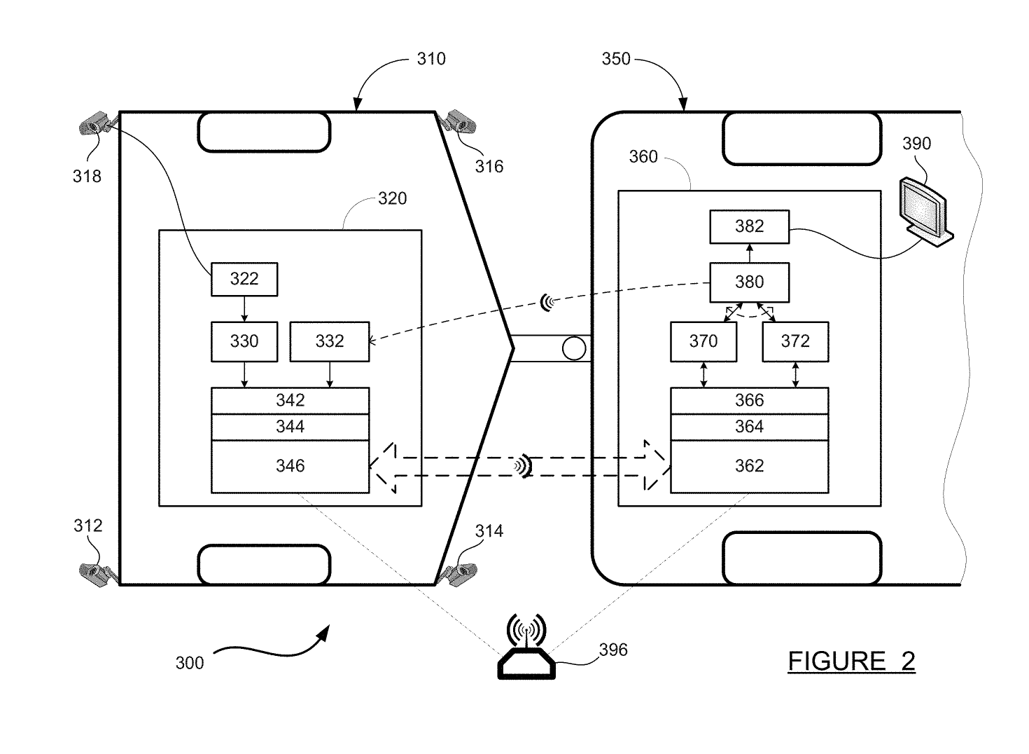

FIG. 2 is a block diagram of a system 300 for managing wireless communications between trailer-mounted cameras and a towing vehicle. The system 300 is designed to address the problem illustrated in FIG. 1, according to the discussion below. The system 300 includes components onboard a trailer 310 and other components onboard a towing vehicle 350 (only the rear portion shown). Trailer-mounted cameras 312, 314, 316 and 318 are mounted at various locations on the trailer 310. The trailer-mounted cameras 312-318 as illustrated are simply representative of the number and locations of cameras which may be used. Of course, more or fewer cameras could be installed on the trailer 310, and the camera locations, orientations, interior/exterior placement, etc. may all be configured as desired.

Each of the trailer-mounted cameras 312-318 includes a transmitting module 320. The transmitting module 320 is shown in FIG. 2 as being associated with the camera 318; however, it is to be understood that each of the cameras 312-318 has the features shown in the transmitting module 320. The camera 318 provides images to an encoder/decoder (codec) 322. The codec 322 converts the video signal from the camera 318 between digital and analog formats, or between different digital formats, as would be understood by one skilled in the art. The codec 322 provides the video signal to a socket 330, which provides the signal to a Wi-Fi tuner/driver 342. The Wi-Fi tuner/driver 342 communicates with a baseband circuit 344, which in turn communicates with a radio frequency (RF) front end 346. The RF front end 346 is capable of communicating on both the frequency bands 100 and 200 . . . that is, on 2.4 GHz and/or 5 GHz. A transmitting channel manager 332 controls the band and channel on which the signal from the RF front end 346 is transmitted, as discussed below.

Onboard the towing vehicle 350 is a receiving module 360. The receiving module 360 includes an RF front end 362, a baseband circuit 364 and a Wi-Fi tuner/driver 366. The RF front end 362 (in the vehicle 350) receives RF signals from the RF front end 346 (on the trailer 310). The baseband circuit 364 converts and delivers the video signal to the Wi-Fi tuner/driver 366. It is to be understood that the RF front end 362 will be able to switch between different channels fast enough such that from application point of view, it is able to operate on multiple channels simultaneously, as shown in FIG. 1, where some transmissions may be desirable signals from the trailer-mounted cameras 312-318, and some transmissions may be undesirable noise from external interference sources.

A scanner 370 and a socket 372 communicate with both the Wi-Fi tuner/driver 366 and a receiving channel manager 380. The receiving channel manager 380 reassembles the video feeds from the trailer-mounted cameras 312-318, on whatever channels they are being communicated, and passes them along to a codec 382. The codec 382 converts the video signals as necessary for display on a display unit 390. The display unit 390 may be a center console display, such as is typically used for navigation and audio/visual system display in vehicles. The display unit 390 may also be incorporated in a rear-view mirror, or elsewhere in the towing vehicle 350.

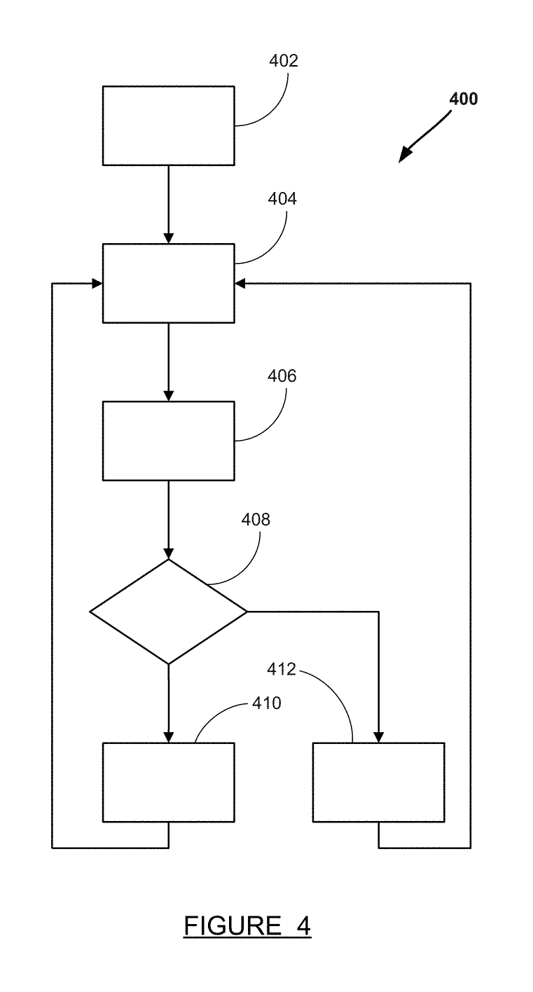

The receiving channel manager 380 performs another important function besides providing video feeds to the codec 382. The channel manager 380 also scans across and monitors conditions on many communications channels—not only the channels currently being used by the transmitting module 320, but other channels as well—and communicates with the transmitting channel manager 332 to dictate which bands and channels should be used for each of the trailer-mounted cameras 312-318. The channel selection method used by the receiving channel manager 380—intended to minimize contentions across all occupied channels—is discussed below in connection with FIG. 4.

It is to be understood that the transmitting channel manager 332 and the receiving channel manager 380 are programmable computing devices including a processor and a memory module. It is to be further understood that the elements shown in the transmitting module 320 and the receiving module 360—from the codecs through the RF front ends—may be combined or realized using different combinations of hardware and software.

The image frame communications between the transmitting module 320 and the receiving module 360 may be compressed using any known technology. For example, the transmissions from the trailer-mounted cameras 312-318 may follow a sequence including i-frames, p-frames and b-frames—where the i-frames are complete image frames, the p-frames are predicted frames holding only the changes in the image from the previous frame, and the b-frames are bi-predictive frames holding only differences between the current frame and both the preceding and following frames. Such compression techniques are known in the art, and are independent from the channel management system and method discussed herein.

FIG. 3 is an illustration of a group of wireless transmissions over multiple channels in multiple frequency bands, where collisions between the transmissions are eliminated by migrating some of the transmissions to different channels using the system 300 of FIG. 2. FIG. 3 shows the same five transmissions (10-50) and the same bands/channels as were shown in FIG. 1. In FIG. 3, all collisions have been eliminated by moving some of the transmissions to different channels. As described previously, the transmissions 10 and 50 are external interference—and there is nothing that the channel manager 380 can do to move or eliminate them. However, the transmissions 20/30/40 are under the control of the channel managers 332/380 of the system 300, and these transmissions can be moved to different channels to alleviate congestion and eliminate collisions.

Comparing FIG. 3 to FIG. 1, it can be seen that the transmissions 10 and 50 remain on the same channels, as they are from an external source and cannot be controlled. The transmissions 30 and 40 are moved from channels 120 and 220, respectively, to channel 210. Being relatively smaller, the transmissions 30 and 40 can both be handled on the channel 210 without contention. Moving the transmission 40 off of channel 220 eliminates the collision 44. Additionally, the transmission 20 is moved from the channel 110 to the channel 120 vacated by the move of the transmission 30. Moving the transmission 20 off of channel 110 eliminates the collision 14. The migration of the transmissions 20-40 to different channels results in a balanced utilization of the channels 110-220, with no contentions. Of course, in a real implementation, many more channels would be in play, and the migration of transmissions to different channels is an ongoing process, not a one-time event. This is discussed further below.

FIG. 4 is a flowchart diagram 400 of a method for selecting wireless frequency bands and channels for the multiple trailer-mounted cameras 312-318 communicating with the towing vehicle 350 of FIG. 2. At box 402, communications are established from one or more of the trailer-mounted cameras 312-318 through the transmitting module 320 to the receiving module 360 of the towing vehicle 350. At box 404, the receiving channel manager 380 evaluates channel conditions of occupied channels by analyzing received data packets. The received data packets can be used to determine the congestion conditions of occupied channels (channels used by the transmitting module 320) by evaluating packet delivery ratio (PDR), end-to-end latency, jitter, or received signal strength indicator (RSSI).

At box 406, the receiving channel manager 380 periodically evaluates channel conditions of non-occupied channels—that is, channels which are not currently being used for communications between the transmitting module 320 and the receiving module 360. The monitoring of the non-occupied channels at the box 406 is a proactive step to identify clear channels which may be used if occupied channels experience congestion and/or collisions. At decision diamond 408, it is determined by the receiving channel manager 380 whether the occupied channels are experiencing congestion or collisions which warrant switching some transmissions to a different channel. If no congestion on the occupied channels is being experienced, then the process continues at box 410 with no channel changed commanded by the receiving channel manager 380, and the process returns to the box 404 to continue channel condition evaluation.

If, at the decision diamond 408, congestion is being experienced, then at box 412 the receiving channel manager 380 commands one or more of the trailer-mounted cameras 312-318 to switch to a different channel. The command is sent from the receiving channel manager 380 to the transmitting channel manager 332, causing the transmitting module 320 to switch to a different channel for at least one device. The different channel may be on the same band (the band 100 or 200) as was previously being used, or may be on a different band. Furthermore, the receiving channel manager 380 may consider band limitations of certain of the trailer-mounted cameras 312-318, and may make combination channel migrations in order to both alleviate congestion and respect device band limitations. An example of a combination channel migration was illustrated in FIGS. 1 and 3, where the transmission 30 was moved from channel 120 to channel 210, the transmission 40 was moved from channel 220 to channel 210 and the transmission 20 was moved from channel 110 to channel 120—and these three channel migrations were made in order to alleviate collision situations on two channels involving external interference.

In monitoring channel conditions and migrating transmissions to different channels, the receiving channel manager 380 may give preference to orthogonal channels, or channels whose signal waveforms have a phase difference of 90 degrees.

Even with the channel migration techniques discussed above, some contentions and collisions will still be inevitable. These contentions and collisions may cause data packet loss which results in reduced quality video display in the towing vehicle 350. It is desirable to mitigate the effects of packet loss as much as possible in the system 300 of FIG. 2. Network coding can be used for this purpose.

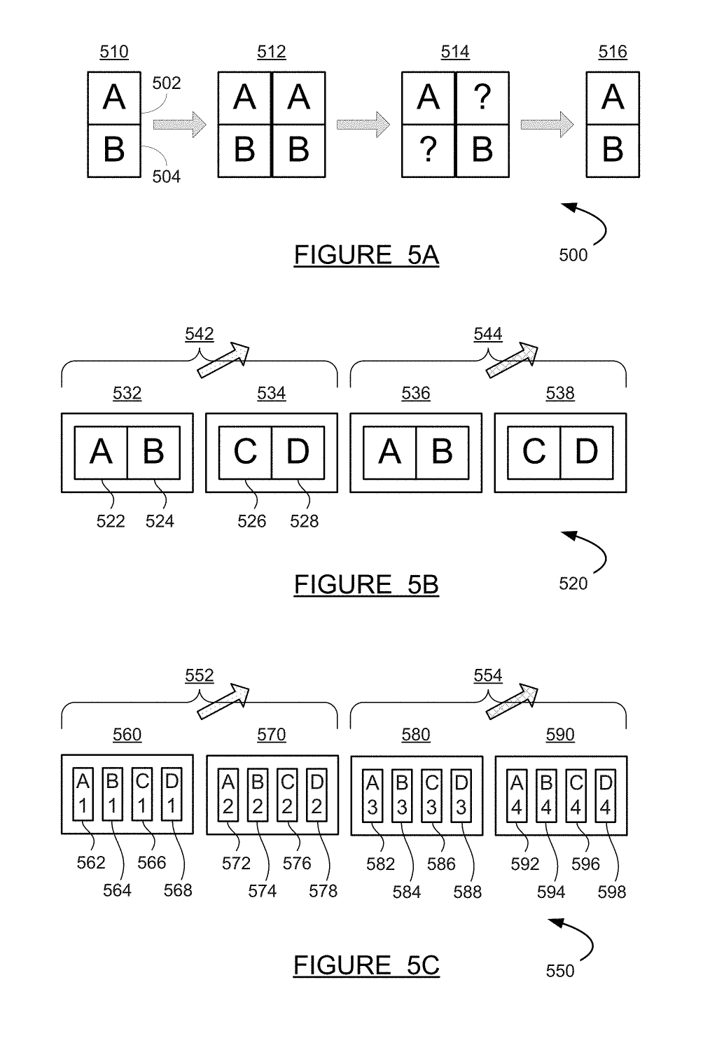

FIGS. 5 A/B/C are conceptual diagrams illustrating how network coding techniques can be used to overcome packet loss and improve video frame recovery. FIG. 5A is an illustration 500 showing a basic concept of added extra redundancy to preemptively counteract uncertainty in loss-prone communications channels. An image frame 502 designated A, and an image frame 504 designated B, are shown at origination 510 and are to be transmitted—for example, transmitted from the transmitting module 320 to the receiving module 360 of FIG. 2. At transmission 512, the image frames 502 and 504 are duplicated—that is, each of them is transmitted twice. This duplication is a preemptive way of counteracting data packet loss at the cost of introducing extra overhead. At reception 514, one copy of the image frame 502 and one copy of the image frame 504 have been at least partially lost in transmission, resulting in the two fully-recovered frames and the two frames with uncertainty. At delivery 516, the intact frames from reception 514 are used to provide full recovery of the original image frames 502 and 504. However, if both copies (original and duplicate) of A are lost or both copies (original and duplicate) of A are lost, the intact image could not be recovered.

The above is just one example of redundancy for loss-mitigation. Other examples include transmitting one full resolution image as the main package, and another one downsized image (or a series of downsized images as an image pyramid) as a redundant package for mitigating data loss. This approach may be advantageous because from an imaging/viewing/image-processing point of view, a few pixels loss or image resolution down-sampling may still be acceptable, but drop-frame or bad-frame are not.

FIG. 5B is an illustration 520 showing how image frame duplication can be used with the system 300 of FIG. 2 to provide a wireless camera communications system which combines the loss-mitigation benefits of duplication with the loss-prevention benefits of adaptive channel management. In this case, four image frames are shown; an image frame 522 designated A and an image frame 524 designated B are included in a packet 532, while an image frame 526 designated C and an image frame 528 designated D are included in a packet 534. The packets 532 and 534 are sent in a transmission 542. In the technique of FIG. 5B, each of the frames is duplicated and sent via a second transmission. This is shown on the right side of FIG. 5B, where packets 536 and 538 contain duplicate copies of image frames A/B and C/D, respectively. The packets 536 and 538 are sent in a transmission 544, which preferably follows a different path than the transmission 542, a concept which is discussed further below.

Using the technique depicted in FIG. 5B, a data packet loss rate of 10% results in a frame error rate of only about 2%. These results demonstrate the loss-mitigation benefits of even a simple frame duplication approach applied to wireless image data transmission. When combined with the packet-loss-prevention benefits of adaptive channel management, a very high quality video stream is achieved.

A more sophisticated and advanced approach is a network coding solution. FIG. 5C is an illustration 550 showing how advanced network coding can be used with the system 300 of FIG. 2 to add even greater loss-mitigation benefits to the loss-prevention benefits of adaptive channel management. In FIG. 5C, four image frames are again shown; A, B, C and D. However, instead of simply duplicating each of the image frames as was done in the simple duplication approach of FIG. 5B, an advanced network coding technique is used. In the example shown, a (4,2) Reed-Solomon error correcting code approach is employed—where each image frame is split into two parts (such as the even and odd interlacing fields of a full frame) and each of the two parts is coded two different ways—resulting in four partial representations (sub-frames) of each of the frames A, B, C and D. For those skilled in this art, it should be understood that other advanced source coding and/or network coding mechanisms could be applied in this scenario; also other types of parameter configurations could be applied in this scenario as well.

In the illustration 550 of FIG. 5C, the image frame data will again be sent in two transmissions, 552 and 554, which again preferably follow different paths from the transmitter to the receiver. The transmission 552 includes packets 560 and 570, and each of the packets includes four image sub-frames. For example, the packet 560 includes a sub-frame 562 which is a first piece of the image A designated A1, a sub-frame 564 which is a first piece of the image B designated B1, a sub-frame 566 which is a first piece of the image C designated C1, and a sub-frame 568 which is a first piece of the image D designated D1. The packet 570 similarly includes four sub-frames 572-578, which contain the second piece of the four frames A/B/C/D. The transmission 554 includes packets 580 and 590, where the packet 580 includes four sub-frames 582-588 which contain the third piece of the four frames A/B/C/D, and the packet 590 includes four sub-frames 592-598 which contain the fourth piece of the four frames A/B/C/D.

In the network coding approach, when the original N pieces of contents are coded into M pieces of coded content (N<M), the original content could be recovered as long as (N+ε) piece of coded content could be recovered. In this particular case, as long as slightly more than 2 piece of these four frames are received correctly, the original content could be fully recovered even if other coded contents are lost due to channel fading or other adversary effects.

Advanced network coding such as the (4,2) Reed-Solomon technique shown in FIG. 5C adds computational overhead to both the transmitting and receiving ends of the system, but also improves error correcting robustness considerably over the naïve duplication of FIG. 5B. Using the advanced network coding approach of FIG. 5C, a data packet loss rate of 10% results in a frame error rate of only about 0.4%—which is a five-fold improvement over the naïve duplication results. Depending on communications channel congestion, packet loss rates, available computational power and other factors, naïve duplication or advanced network coding may be chosen for a particular application.

The duplication and network coding techniques of FIGS. 5B and 5C require computations on both the transmitting and receiving ends. These computations may occur in any suitable element within the transmitting module 320 and the receiving module 360. For example, if the transmitting channel manager 332 is positioned in-line between the codec 322 and the socket 330, the network coding may be performed in the channel managers 332/380.

In the duplication and network coding techniques of FIGS. 5B and 5C discussed above, the concept of sending two data transmissions (the two parts of a corresponding pair) via different paths is introduced as a means of providing robustness against packet loss. Two techniques for path differentiation are proposed—spectral diversity, and spatial diversity.

Spectral diversity refers to sending the two data transmissions (542 and 544 in FIG. 5B, or 552 and 554 in FIG. 5C) over different ISM bands. Leveraging the high-speed switching capability of the Wi-Fi chipset in the circuits 342/344/346 of the transmitting module 320, the network-coded data packets can be transmitted over the 2.4 GHz and 5 GHz bands (bands 100 and 200) almost simultaneously. The 2.4 GHz and 5 GHz bands are highly uncorrelated—meaning that any errors or erasures experienced by data packets sent over the 2.4 GHz band are extremely unlikely to also be experienced by a companion data packet transmitted over the 5 GHz band. For example, in FIG. 5C, if the sub-frame 572 (A2) is lost in the transmission 552 sent over the 2.4 GHz band, it is extremely unlikely that the sub-frame 592 (A4) will also be lost in the transmission 554 sent over the 5 GHz band. Thus, even with the loss of A2, enough data will be available on the receiving end to fully recover the A frame. This benefit of spectral diversity further improves the reliability of data transmissions using duplication or network coding.

Spatial diversity refers to sending the two data transmissions (542 and 544 in FIG. 5B, or 552 and 554 in FIG. 5C) over different physical routes from transmitter to receiver. Referring back to FIG. 2—the first transmission (552) can be sent directly from the transmitting module 320 to the receiving module 360, while the corresponding second transmission (554) can be sent from the transmitting module 320 to the receiving module 360 via a repeater 396. The two signal paths, direct vs repeated, are highly uncorrelated—meaning that any errors or erasures experienced by data packets sent over the direct path are extremely unlikely to also be experienced by a companion data packet transmitted over the repeated path. The repeater 396 also provides range extension for any of the cameras 312-318 which may be near the edge of their wireless signal range from the receiving module 360—such as for long trailers, or cameras mounted in obstructed locations in or on a trailer. The benefits of spatial diversity illustrated above further improve the reliability of data transmissions using duplication or network coding.

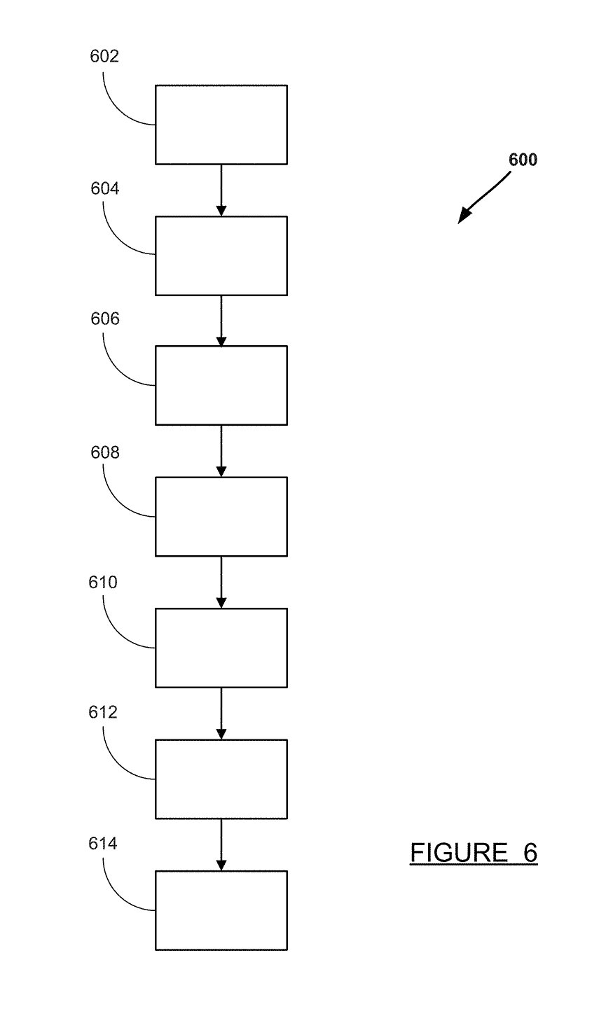

FIG. 6 is a flowchart diagram of a method 600 for managing wireless communications between trailer-mounted cameras and a towing vehicle. The method 600 of FIG. 6 incorporates all of the channel management, network coding and path differentiation techniques discussed above. At box 602, communications are established from one or more of the trailer-mounted cameras 312-318 through the transmitting module 320 to the receiving module 360 of the towing vehicle 350.

At box 604, the channels and bands used for transmission are evaluated and optimized by the receiving channel manager 380. The actions taken at the box 604 were detailed earlier in the flowchart diagram 400 of FIG. 4—where the receiving channel manager 380 monitors both occupied and non-occupied channels, and instructs the transmitting channel manager 332 to change channels and/or bands as necessary to alleviate any communications congestion which is being experienced on occupied channels.

At box 606, image frames from the trailer-mounted cameras 312-318 are processed by the transmitting module 320 using duplication or network coding, where image frame redundancy is added to data packets to be transmitted, and the data packets are arranged in corresponding pairs of transmissions. Simple duplication or advanced network coding may be used, as discussed above. As discussed above, the network coding may be performed in the channel manager 332, or in another component of the transmitting module 320. At box 608, each corresponding pair of transmissions is wirelessly transmitted from the transmitting module 320 to the receiving module 360. Each corresponding pair of transmissions may be sent via two different paths from the transmitting module 320 to the receiving module 360. That is, one half of each pair is sent via a first path, and the other half of each pair is sent via a second path, where the different paths may employ spectral diversity or spatial diversity.

At box 610, the corresponding pairs of transmissions are received by the receiving module 360. At box 612, the receiving module decodes the received transmissions, including converting the network-coded image frames contained in the data packets back to whole image frames. At box 614, the image frames are displayed on a display unit connected to the receiving module 360—such as the display 390 in the towing vehicle 350.

The method of FIG. 6 and the apparatus of FIG. 2 provide for simple, high-reliability wireless communication of images from cameras to a remote receiver/display—such as from trailer-mounted cameras to a towing vehicle. The combination of channel and spectrum hopping, network coding and path diversity result in a wireless image transmission solution which first minimizes data packet loss and then mitigates the adverse effects of any packets which are lost. Using these techniques, cameras can be added to a trailer with performance and reliability comparable to that of a hardwired connection, but the simplicity and flexibility of a wireless implementation.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for managing wireless communications between cameras and a remote display, said method comprising:
providing images from one or more cameras to a transmitting module;
establishing wireless communications between the transmitting module and a receiving module;
monitoring channel traffic conditions on multiple channels by the receiving module and signaling the transmitting module to change frequency bands and/or channels in order to minimize contentions on occupied channels;
processing image frames from the cameras by the transmitting module using network coding, including coding the image frames into data packets which are grouped into corresponding pairs of transmissions;
transmitting each corresponding pair of transmissions from the transmitting module to the receiving module, where one portion of each corresponding pair is transmitted via a different path than a remaining portion of the corresponding pair;
receiving the transmissions by the receiving module;
decoding the data packets by the receiving module to reconstruct the image frames; and
providing the image frames from the receiving module to a display device for visual display.

2. The method of claim 1 wherein monitoring channel traffic conditions by the receiving module includes continuously evaluating channel traffic conditions on occupied channels, where occupied channels are channels on which the receiving module is currently receiving transmissions from the transmitting module.

3. The method of claim 2 wherein monitoring channel traffic conditions by the receiving module includes periodically evaluating channel traffic conditions on non-occupied channels, where non-occupied channels are channels on which the receiving module is not currently receiving transmissions from the transmitting module.

4. The method of claim 3 wherein signaling the transmitting module to change frequency bands and/or channels includes identifying occupied channels experiencing congestion, determining which congestion is being caused by external source interference, identifying clear channels among the non-occupied channels, and transmitting an instruction from the receiving module to the transmitting module to migrate from a channel experiencing congestion to a clear channel.

5. The method of claim 1 wherein signaling the transmitting module to change frequency bands and/or channels includes wirelessly signaling the transmitting module, by the receiving module, to switch from a currently-used channel to an orthogonal channel in a same frequency band, where the orthogonal channel is a channel whose signal waveform is 90° out of phase with a signal waveform of the currently-used channel, or in a different frequency band.

6. The method of claim 1 wherein processing image frames from the cameras by the transmitting module using network coding includes duplicating each of the image frames and placing a copy of each image frame in each of the two halves of the corresponding pair of transmissions.

7. The method of claim 1 wherein processing image frames from the cameras by the transmitting module using network coding includes splitting each of the image frames into a first number of pieces, appending error correction codes to the first number of pieces to produce a second number of sub-frames, where the second number is greater than the first number, and dividing the sub-frames between the two portions of the corresponding pair of transmissions.

8. The method of claim 1 wherein the different path is a different frequency band.

9. The method of claim 1 wherein the different path is a different physical route, where one portion of each corresponding pair is transmitted directly from the transmitting module to the receiving module and the remaining portion of the corresponding pair is transmitted from the transmitting module to a repeater and then to the receiving module.

10. The method of claim 1 wherein the one or more cameras are mounted on a trailer and the display device is onboard a vehicle which is towing the trailer.

11. A method for managing wireless communications between trailer-mounted cameras and a towing vehicle, said method comprising:
providing images from one or more trailer-mounted cameras to a transmitting module on a trailer;
wirelessly transmitting the images from the transmitting module on the trailer to a receiving module on the towing vehicle;
continuously monitoring traffic conditions on occupied channels by the receiving module, where occupied channels are channels on which the receiving module is currently receiving transmissions from the transmitting module;
periodically evaluating traffic conditions on non-occupied channels, where non-occupied channels are channels on which the receiving module is not currently receiving transmissions from the transmitting module;
determining whether any of the occupied channels are experiencing congestion causing data packet loss;
identifying, for each of the occupied channels which are experiencing congestion causing data packet loss, a different channel to migrate to; and
wirelessly communicating, from the receiving module to the transmitting module, to migrate transmission from the channel experiencing congestion to the different channel.

12. The method of claim 11 wherein the different channel is an orthogonal channel in a same frequency band, where the orthogonal channel is a channel whose signal waveform is 90° out of phase with a signal waveform of the channel experiencing congestion.

13. The method of claim 11 wherein the different channel is in a different frequency band.

14. The method of claim 11 wherein the different channel is selected from clear channels identified among the non-occupied channels.

15. A system for managing wireless communications between cameras and a remote display, said system comprising:
one or more cameras providing image frames;
a transmitting module configured to receive the image frames from the one or more cameras, code the image frames into data packets which are grouped into corresponding pairs of transmissions, and wirelessly transmit the transmissions over one or more radio frequency (RF) channels, where one half of each corresponding pair is transmitted via a different path than the other half of the corresponding pair;
a receiving module configured to receive the transmissions and process the data packets to reconstruct the image frames, where the receiving module is also configured to monitor channel traffic conditions and wirelessly signal the transmitting module to change frequency bands and/or channels in order to minimize contentions on occupied channels; and
a display device in communications with the receiving module, said display device displaying the received images for viewing.

16. The system of claim 15 wherein the receiving module continuously evaluates channel traffic conditions on occupied channels, where occupied channels are channels on which the receiving module is currently receiving transmissions from the transmitting module, periodically evaluates channel traffic conditions on non-occupied channels, where non-occupied channels are channels on which the receiving module is not currently receiving transmissions from the transmitting module, identifies occupied channels experiencing congestion, determines which congestion is being caused by external source interference, and identifies clear channels among the non-occupied channels.

17. The system of claim 16 wherein the receiving module signals the transmitting module to migrate from a channel experiencing congestion to a clear channel, where the clear channel is an orthogonal channel on a same frequency band as the channel experiencing congestion or the clear channel is on a different frequency band from the channel experiencing congestion.

18. The system of claim 15 wherein the transmitting module codes the image frames using network coding, including splitting each of the image frames into a first number of pieces, appending error correction codes to the first number of pieces to produce a second number of sub-frames, where the second number is greater than the first number, and dividing the sub-frames between the two portions of the corresponding pair of transmissions.

19. The system of claim 15 wherein the different path is a different physical route, where one portion of each corresponding pair is transmitted directly from the transmitting module to the receiving module and the remaining portion of the corresponding pair is transmitted from the transmitting module to a repeater and then to the receiving module.

20. The system of claim 15 wherein the one or more cameras are mounted on a trailer and the display device is onboard a vehicle which is towing the trailer.
